(19) United States
(12) Patent Application Publication
(10) Pub. No.: US 2024/0143351 A1
(43) Pub. Date: May 2, 2024

(54) SYSTEMS AND METHODS FOR ADVANCED USER INTERFACES WITH CUSTOMIZABLE CONTAINERS

(71) Applicant: State Farm Mutual Automobile Insurance Company, Bloomington, IL (US)

(72) Inventor: Christopher M. Davis, Bloomington, IL (US)

(21) Appl. No.: 18/492,119

(22) Filed: Oct. 23, 2023

Related U.S. Application Data
(60) Provisional application No. 63/381,684, filed on Oct. 31, 2022.

(51) Int. Cl. G06F 9/451; G06F 21/31

(52) U.S. Cl. CPC G06F 9/451; G06F 21/31

(57) ABSTRACT

A computer system for generating a customizable user interface may be provided. The computer system may be programmed to (i) receive an indication to activate a customization mode for a user interface from an end user; (ii) determine a role and one or more permissions for the end user; (iii) retrieve one or more containers of data elements based on the role for the end user; (iv) populate each of the one or more containers with a plurality of data elements based on the one or more permissions for the end user; (v) display the customization mode for the user interface including the one or more containers to the end user; (vi) receive one or more changes to the user interface from the end user; and (vii) update a profile for the end user based on the one or more changes.

### CROSS REFERENCE TO RELATED APPLICATIONS

This application claims the benefit of priority to U.S. Provisional Patent Application No. 63/381,684, filed on Oct. 31, 2022, which is hereby incorporated by reference in its entirety.

### FIELD OF DISCLOSURE

The present disclosure relates to advanced user interfaces and, more particularly, to network-based systems and methods for generating user customizable user interfaces by providing data elements in customizable containers.

### BACKGROUND

In many situations, user interfaces are generally designed as a “one-size-fits-all” solution pushed out to end users. However, different users may require access to different information based on their roles. Furthermore, users may have individual preferences about what information is important to them in their role. In addition, some users may have different levels of visual acuity requiring different font sizes, colors, and/or contrasts to easily view their user interface. In some situations, a poorly designed user interface may have a negative impact on user productivity. For example, some user interfaces may be crowded with information making it difficult for users to find the information that they are looking for because there are too many fields in their view.

Accordingly, it would be useful for users to have a way to individualize their experiences with their own user interface, while still keeping the development and support of said user interfaces manageable. Conventional techniques may have other inefficiencies, encumbrances, ineffectiveness, and/or drawbacks as well.

### BRIEF SUMMARY

The present embodiments may relate to, inter alia, network-based systems and methods for generating user customizable user interfaces by providing data elements in customizable containers. A customizable user interface system, as described herein, may include a customizable user interface (“CUT”) computer device that is in communication with a user computer device. The CUI computer device may be configured to (1) receive an indication to activate a customization mode for a user interface from an end user; (2) determine a role and one or more permissions for the end user; (3) retrieve one or more containers of data elements based on the role of the end user; (4) populate each of the one or more containers with a plurality of data elements based on the one or more permissions for the end user; (5) display the customization mode for the user interface including the one or more containers to the end user; (6) receive one or more changes to the user interface from the end user; and/or (7) update a profile for the end user based on the one or more changes.

The CUI computer device may be configured to: (i) retrieve the profile for the end user from a database; and/or (ii) retrieve the role and the one or more permissions from the profile. The CUI computer device may be further configured to: (1) store a plurality of profiles for a plurality of end users; (2) retrieve the first profile for the first end user in response to receiving an indication that a first end user of the plurality of end users is logging in; (3) generate a first user interface for the first end user based on the first profile; and (4) transmit the first user interface to a user computer device associated with the first end user to display the first user interface to the first end user, wherein the first user interface that is displayed includes the elements requested by the user and arranged on the display screen in a way that is also requested or customized by the user. Thus, the CUI computer device enables an end user to easily customize a user interface that will be displayed to the end user, and causes the user interface to be displayed to that end user with the data elements requested by the end user and arranged in the way also requested by the end user. In addition, the CUI computer device may be configured to provide user interfaces that are customizable by the individual user and store the design of each individual user's interface to provide each user with an individualized experience.

In one aspect, a computer system for generating a customizable user interface may be provided. The computer system may include one or more local or remote processors, transceivers, servers, sensors, memory units, wearables, mobile devices, smart glasses, smart watches, augmented reality glasses, virtual reality headsets, and/or other electronic or electrical components. For example, in one instance, the system may include at least one processor (and/or associated transceiver) in communication with at least one memory device. The at least one processor may be configured or programmed to: (1) receive an indication to activate a customization mode for a user interface from an end user; (2) determine a role and one or more permissions for the end user; (3) retrieve one or more containers of data elements based on the role for the end user; (4) populate each of the one or more containers with a plurality of data elements based on the one or more permissions for the end user; (5) display the customization mode for the user interface including the one or more containers to the end user; (6) receive one or more changes to the user interface from the end user; and/or (7) update a profile for the end user based on the one or more changes. The computer system may have additional, less, or alternate functionality, including that discussed elsewhere herein.

In another aspect, a computer-based method for generating a customizable user interface may be provided. The computer-based method may be implemented via one or more local or remote processors, transceivers, sensors, servers, memory units, mobile devices, wearables, smart glasses, smart watches, augmented reality glasses, virtual reality headsets, and/or other electronic or electrical components. For example, in one instance, the method may be implemented on a customizable user interface (“CUI”) server that includes at least one processor (and/or associated transceiver) in communication with at least one memory device. The method may include, via the at least one processor: (1) receiving an indication to activate a customization mode for a user interface from an end user; (2) determining a role and one or more permissions for the end user; (3) retrieving one or more containers of data elements based on the role for the end user; (4) populating each of the one or more containers with a plurality of data elements based on the one or more permissions for the end user; (5) displaying the customization mode for the user interface including the one or more containers to the end user; (6) receiving one or more changes to the user interface from the end user; and/or (7) updating a profile for the end user based on the one or more changes. The method may include additional, less, or alternate actions, including those discussed elsewhere herein.

In yet another aspect, at least one non-transitory computer-readable storage media having computer-executable instructions embodied thereon may be provided. When executed by at least one processor, the computer-executable instructions cause the processor to: (1) receive an indication to activate a customization mode for a user interface from an end user; (2) determine a role and one or more permissions for the end user; (3) retrieve one or more containers of data elements based on the role for the end user; (4) populate each of the one or more containers with a plurality of data elements based on the one or more permissions for the end user; (5) display the customization mode for the user interface including the one or more containers to the end user; (6) receive one or more changes to the user interface from the end user; and/or (7) update a profile for the end user based on the one or more changes. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIGS. 1A and 1B illustrate views of customizable user interfaces with customizable containers in accordance with one embodiment of this disclosure.

FIG. 2 illustrates a simplified block diagram of an exemplary computer system for implementing the customizable user interfaces shown in FIG. 1.

FIG. 3 illustrates a flow chart of an exemplary computer-implemented process for providing a customizable user interface using the system shown in FIG. 2.

FIG. 4 illustrates an exemplary configuration of a client computer device shown in FIG. 2, in accordance with one embodiment of the present disclosure.

FIG. 5 illustrates an exemplary configuration of a server shown in FIG. 2, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for advanced, customized user interfaces and, more particularly, to network-based systems and methods for generating user customizable user interfaces by providing data elements in customizable containers. In the exemplary embodiment, a customizable user interface (“CUI”) computer device (also known as a CUI server) allows user to customize their user interface to provide the information that they want where they want it in their user interface using a customization mode.

The customization mode includes a “bank” or repository of predefined data elements within the user interface that allow the end user to customize what data elements to show as well as where the data elements go on the user interface. In some embodiments, data elements in the same family may be grouped together to form “containers.” These containers are similar to widgets and allow for the easy transfer of data elements to and from the user interface. When the customization mode is activated, the containers associated with that end user are displayed. The system may determine which containers to display based on one or more roles and/or permissions associated with the end user.

In the exemplary embodiment, the CUI server is in communication with one or more databases. The databases include a plurality of profiles for the user interfaces of users. The profiles include the data elements that are presented to the user and where those data elements are located within the user interface. The system enables the user to select the data elements to be presented along with how those data elements are arranged on the display screen to the user. Furthermore, the profiles may store other attributes of the data elements, such as, but not limited to, font type used, font size, font color, background color, data element size, and/or any other attribute of the data elements included on the customized user interface. Each user may have their own profile stored in the database. As explained below, these profiles may be stored in a database on the server-side of the system, or each user profile may be pushed out from the database and stored on each end user's device that is used for accessing the data.

When a user logs into the system, the user's profile is retrieved (e.g., either from the database or the end user's device), and the user computer device generates and presents the user interface to the end user based on the user's profile. The user may customize their user interface by entering a customization mode. This customization mode may be activated, for example, by a button on the user interface or by a menu option. When in the customization mode, the user is allowed to move and/or alter data elements on their user interface. This alteration may include, but is not limited to, size, color, font, etc. The user's changes are then saved in the profile. The user may “drag and drop” data elements into different locations on the user interface.

In the exemplary embodiment, the customization mode may also present one or more containers of data elements that the user may add to their user interface. In at least one embodiment, the user may drag data elements from a container and drop the desired elements onto the user interface. The user may also drag data elements from the user interface into the container to remove those elements from the user interface. When the user is finished with customization mode, they can save their changes to the user interface in their profile.

In some embodiment, the profile includes all of the information about all of the data elements shown in the user's preferred user interface. In other embodiments, the profile only includes those changes that the user made from a base template. In these embodiments, the system may provide a base template that places and displays data elements based on some information about the user, such as permissions and/or role. The template can then be used as the starting point for users when customizing their user interfaces.

In further embodiments, the user interface can be configured by the user to make it easier to look at and/or work with. For example, the user may specify the size of the fonts to make the data easier to work with and/or view. In some of these embodiments, the user may change the color of the fonts and/or the background to reduce the possibility of eyestrain.

In some further embodiment, the data elements in the container that the user is able to select from are limited based on the permissions and/or role of the user. In some of these embodiments, different containers are available to different users based on their permissions and/or roles. For example, the user may be in customer service and be able to view some of the information associated with the customer accounts. While another user may be in billing and have access to the billing information of the customer. In a further embodiment, a user may be in marketing and just have access to the name and address of the customers. In the above examples, the first end user may have access to a customer service specific container of data elements, while the second user may have access to a billing department specific container of data elements.

In some further embodiments, some of the data elements displayed on the user interface may only be visible to the user if the system has data for a specific type of customer, policy, vehicle, or other item. For example, if a first data element displays a vehicle make and model, that first data element may not be shown if the end user is looking at a homeowner's insurance policy.

In some additional embodiments, the individually customized user interfaces may be configured to work with individual departments, such as displaying a billing account where the end user can choose if and where the due date on an account is displayed. In other embodiments, the customized user interfaces may be used by multiple departments within a business organization and may be required to provide information from across multiple departments. For example, a user interface may display the account history for a customer on the same page as the current billing status on the same page as other information from other departments.

In some of these embodiments, each department has its own container of data elements. The end user would be able to use the customization mode, at any time, to rearrange these elements to suit their specific needs. For example, one end user may find it beneficial to have the customer's bill due date, amount, and account billing on the top of the page and easily available for viewing. Another end user may find is more useful to have the policy statuses, payment history, and billing history front and center on the interface. Each end user would be able to easily customize their user interface by selecting and moving these data elements from the multi-department container(s).

In some embodiments, the information available to the user may be limited by one or more attributes of the customer or client that is associated with the records being viewed. In these embodiments, the customer or client may be a minor and the information displayed is limited to comply with local laws. In other embodiments, the information may be different based on where the customer or client is located, with one geographic area having one or more data elements that are not used in another geographic area.

In some embodiments, the user interface is displayed on a display device, such as a display screen. In other embodiments, the user interface is displayed in a virtual or augmented reality environment, where the user interface is presented to the user via augmented reality or virtual reality headsets or glasses.

At least one of the technical problems addressed by this system may include: (i) improving productivity of using a user interface by allowing for the customization of each user interface by the end user of the interface; (ii) improving accessibility of data on a user interface within work environments to users having physical or other limitations and/or disabilities; (iii) improving the human response to and/or interactions with user interfaces; (iv) providing improved accuracy of data provided to users; (v) removing the cycle time between end user comments and developer roll outs of newly designed systems; and/or (vi) improving the process of customizing user interfaces making it more user friendly.

The methods and systems described herein may be implemented (i) using computer programming or engineering techniques including computer software, firmware, hardware, or any combination or subset thereof, and/or (ii) by using one or more local or remote processors, transceivers, servers, sensors, servers, scanners, AR or VR headsets or glasses, smart glasses, and/or other electrical or electronic components, wherein the technical effects may be achieved by performing at least one of the following steps: (1) receive an indication to activate a customization mode for a user interface from an end user; (2) determine a role and one or more permissions for the end user; (3) retrieve one or more containers of data elements based on the role for the end user; (4) populate each of the one or more containers with a plurality of data elements based on the one or more permissions for the end user; (5) display the customization mode for the user interface including the one or more containers to the end user; (6) receive one or more changes to the user interface from the end user; and/or (7) update a profile for the end user based on the one or more changes.

### Exemplary Customizable User Interface

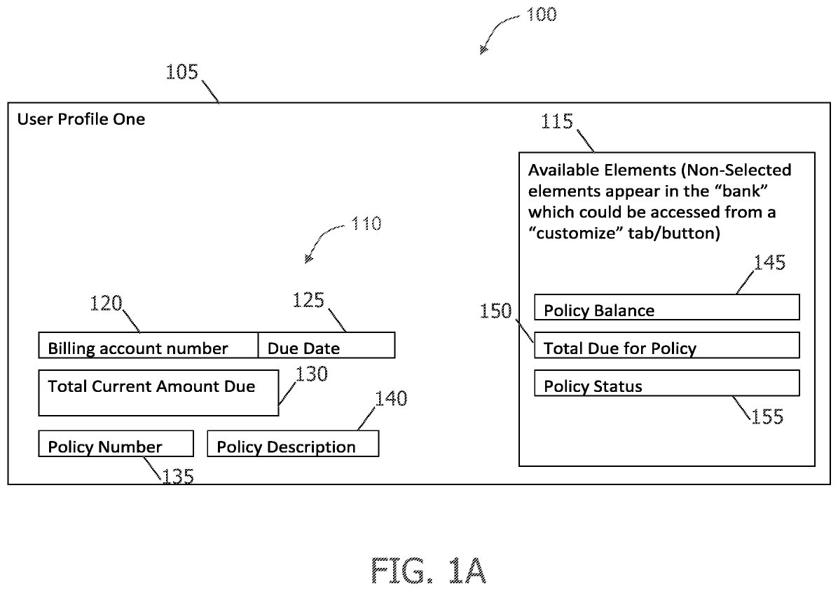

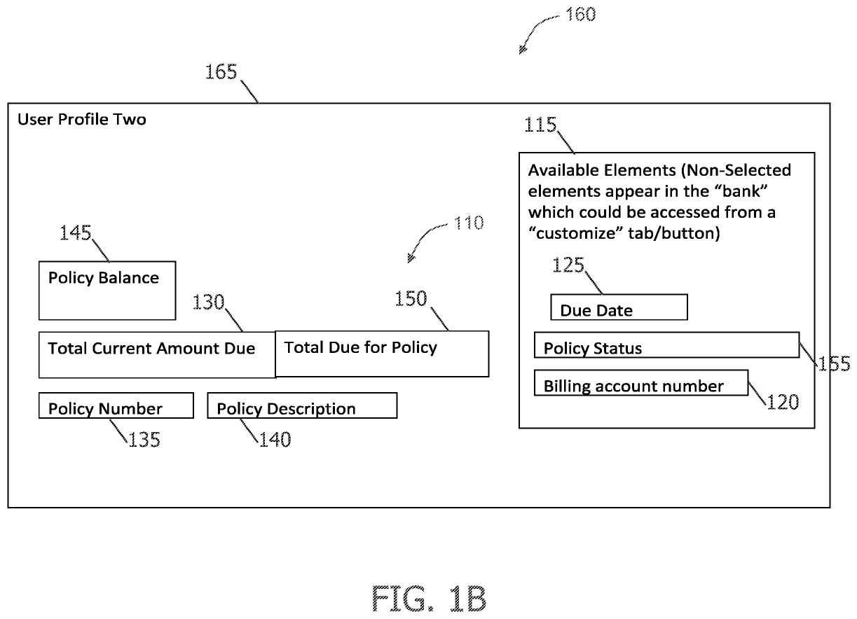

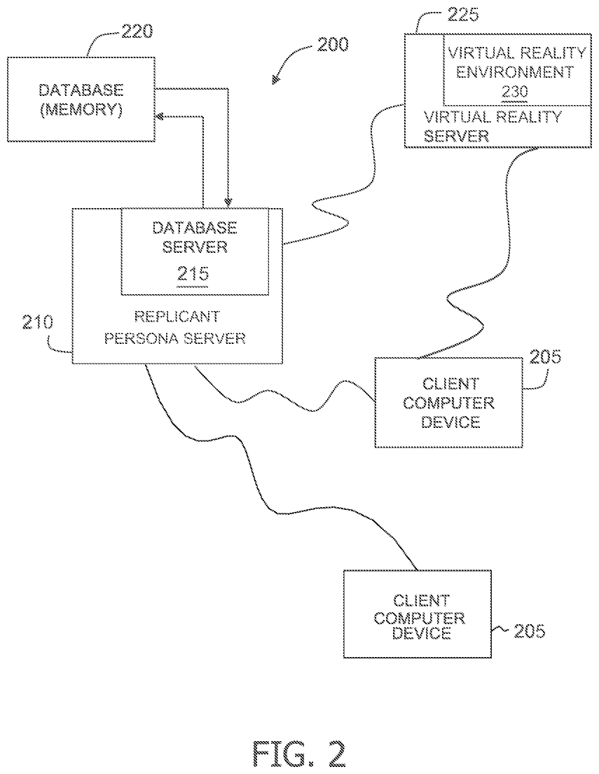

FIG. 1A illustrates a view 100 of a first customizable user interface 105 with customizable containers 115 in accordance with one embodiment of this disclosure. In FIG. 1A, the first customizable user interface 105 is provided to the user via a user computer device 205 (shown in FIG. 2). View 100 shows the first customizable user interface 105 in a customization mode.

The customization mode includes a “bank” or repository of predefined data elements within the user interface 105 that allow the end user to customize what data elements 110 to show as well as where the data elements 110 go on the user interface 105. In some embodiments, data elements in the same family may be grouped together to form containers 115. These containers 115 may be similar to widgets and allow for the easy transfer of data elements 110 to and from the user interface 105. The container(s) 115 may be displayed on the customization mode screen, where the container 115 includes a list of data elements 110 that can be selected by the end user. For example, as shown in FIGS. 1A and 1B, the container 115 may appear on the right-side of the total display area and include a list of data elements 110 that are available for display on the user interface 105. The data elements 110 in the container 115 may be clicked on or select by the end user in the container 115 and moved to another area on the user interface 105.

In the customization mode, the first customizable user interface 105 displays a plurality of data elements 110 and a customizable container 115. The data elements 110 outside of the container 115 are displayed on the customization mode user interface in the positions (absolute and/or relative) that they would appear on the live user interface. In this example, the data elements of billing account number 120, due date 125, total current amount due 130, policy number 135, and policy description 140 are shown on the live portion of the first customizable user interface 105. Three data elements 110, policy balance 145, total due for policy 150, and policy status 155 are displayed in the container 115 and will not appear on the live user interface.

The user may select any of the data elements 110 and move them around the live portion, such as through a drag and drop operation or other movement operation. The user may select data elements 110 in the container 115 and drag those data elements 110 to the live portion. The user may also select data elements 110 on the live portion and drag them to the container 115 to remove those data elements from the live portion. In some embodiments, the user may delete data elements 110 in the live portion. In these embodiments, when deleted, the data element 110 will appear in the container 115.

In some further embodiments, the user may have access to multiple containers 115, which each have multiple data elements 110. The different containers 115 may contain data elements for different roles, types of customers, or other differentiations.

Once the customization mode is completed, the data elements 110 on the user interface 105 may be saved in their current positions, and those data elements 110 and their positions may be saved in the user profile. The user profile may be saved on the user computer device 205 (shown in FIG. 2) and/or on the CUI server 210 (shown in FIG. 2)

FIG. 1B illustrates a view 160 of a second customizable user interface 165 with customizable containers 115 in accordance with one embodiment of this disclosure. In FIG. 1B, the second customizable user interface 165 is provided to the user via a user computer device 205 (shown in FIG. 2). View 160 shows the second customizable user interface 165 in a customization mode.

In view 160, several of the data elements 110 have moved in relation to view 100. In view 160, the policy balance 145 and the total due for policy 150 data elements 110 are in the live portion, while the due date 125 and the billing account number 120 data elements 110 have been moved to the container 115.

### Exemplary Computer Network

FIG. 2 illustrates a simplified block diagram of an exemplary computer system 200 for implementing the customizable user interfaces 105 and 165 (shown in FIG. 1). In the exemplary embodiment, system 200 may be used for archiving and providing user interfaces customized by each individual user. As described below in more detail, a customizable user interface (“CUT”) server 210 may be configured to (1) receive an indication to activate a customization mode for a user interface from an end user; (2) determine a role and one or more permissions for the end user; (3) retrieve one or more containers of data elements based on the role for the end user; (4) populate each of the one or more containers with a plurality of data elements based on the one or more permissions for the end user; (5) display the customization mode for the user interface including the one or more containers to the end user; (6) receive one or more changes to the user interface from the end user; and/or (7) update a profile for the end user based on the one or more changes.

In the exemplary embodiment, user computer devices 205 are computers that include a web browser or a software application, which enables user computer devices 205 to access CUI server 210 using the Internet. More specifically, user computer devices 205 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computer devices 205 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, or other web-based connectable equipment or mobile devices.

A database server 215 may be communicatively coupled to a database 220 that stores data. In one embodiment, database 220 may include profiles, containers 115, data elements 110 (both shown in FIG. 1), and/or information to fill the data elements 110. In the exemplary embodiment, database 220 may be stored remotely from CUI server 210. In some embodiments, database 220 may be decentralized. In the exemplary embodiment, a person may access database 220 via user computer devices 205 by logging onto CUI server 210, as described herein.

CUI server 210 may be communicatively coupled with one or more the user computer devices 205. In some embodiments, CUI server 210 may be associated with, or is part of a computer network associated with business, or in communication with the business' computer network (not shown). In other embodiments, CUI server 210 may be associated with a third party and is merely in communication with the business' computer network.

### Exemplary Computer-Implemented Method for Providing Customizable User Interface

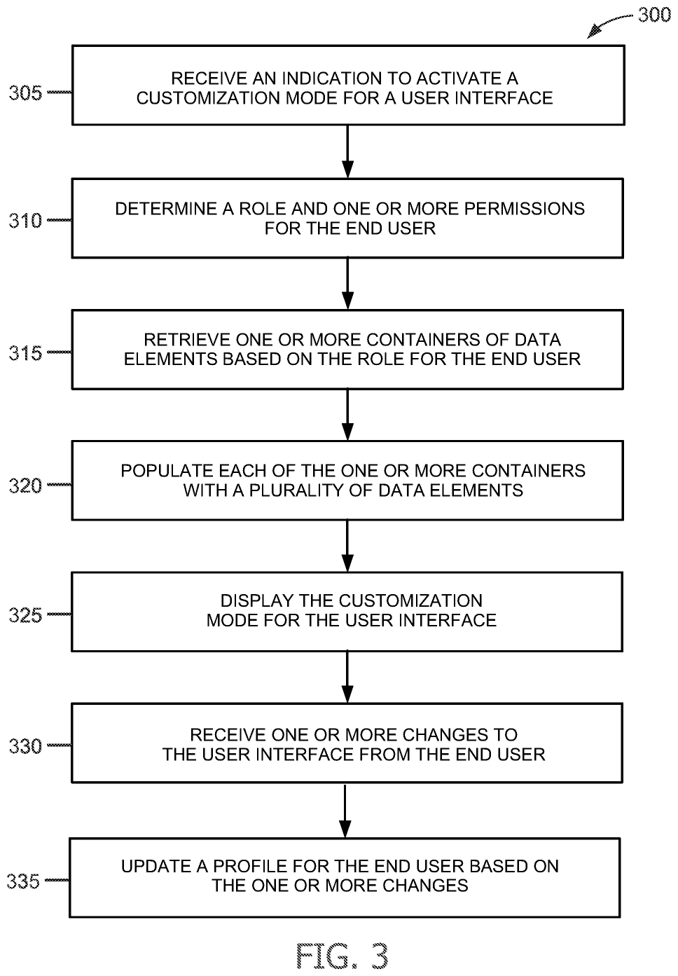

FIG. 3 depicts a flow chart of an exemplary computer-implemented process 300 for providing a customizable user interface 105 (shown in FIG. 1) using the system 200 shown in FIG. 2. Process 300 may be implemented by a computing device, for example CUI server 210 (shown in FIG. 2). In the exemplary embodiment, CUI server 210 may be in communication with one or more client computer devices 205 (shown in FIG. 2).

In the exemplary embodiment, the CUI server 210 receives 305 an indication to activate a customization mode for a user interface 105 from an end user. In some embodiments, the indication to activate the customization mode is based on an input from the end user. The end user may activate the customization mode by pressing a button or selecting a menu option on the user interface 105.

In the exemplary embodiment, the CUI server 210 determines 310 a role and one or more permissions for the end user. The CUI server 210 retrieves the profile for the end user from a database 220 (shown in FIG. 2). The CUI server 210 retrieves the role and the one or more permissions from the profile. In some embodiments, a single profile for the user includes the roles, permissions, and user interface information for the user. In other embodiments, a first profile may include the role and/or permissions, while a second, separate profile includes the user interface information.

In the exemplary embodiment, the CUI server 210 retrieves 315 one or more containers 115 of data elements 110 (both shown in FIG. 1) based on the role for the end user. In some embodiments, an end user may have multiple roles and the CUI server 210 retrieves 315 a container 115 for each of the roles of the end user.

In the exemplary embodiment, the CUI server 210 populates 320 each of the one or more containers 115 with a plurality of data elements 110 based on the one or more permissions for the end user. In some embodiments, the end user has access to some information but not other information. The CUI server 210 provides only the data elements 110 that display the information that the end user has access to.

In the exemplary embodiment, the CUI server 210 displays 325 the customization mode for the user interface 105 including the one or more containers 115 to the end user. For example, the user interfaces 105 and 165 (shown in FIG. 1) illustrate embodiments of the customization mode. In at least one embodiment, the customization mode is displayed on a user computer device 205 (shown in FIG. 2) of the end user.

In the exemplary embodiment, the CUI server 210 receives 330 one or more changes to the user interface 105 from the end user. In at least one embodiment, the end user enters one or more changes to the user interface 105 via their user computer device 205. The CUI server 210 updates 335 a profile for the end user based on the one or more changes. In some embodiments, the end user saves the changes to their user profile.

In some further embodiments, the CUI server 210 stores a plurality of profiles for a plurality of end users. The profiles may include a plurality of data elements 110 to display and a plurality of locations on the user interface 105 to display the plurality of data elements 110. The profiles may include at least one of a size of one or more of the plurality of data elements, a color of one or more of the plurality of data elements, a font of one or more of the plurality of data elements, or a color of a font of one or more of the plurality of data elements.

In some embodiments, there may be one user profile for each end user. In some further embodiments, there may be a user profile for each end user for each program that they interact with. In some further embodiments, the user profile may include user interface information for multiple different screens in a program or application.

In at least one embodiment, the CUI server 210 retrieves a first profile for a first end user from a database 220. In some embodiments, the user profile is stored on the user computer device 205. The CUI server 210 generates a first user interface 105 for the first end user based on the first profile. In some further embodiments, the user computer device 205 generates the first user interface 105 for the end user based on the first profile. The CUI server 210 may retrieve the first profile for the first end user in response to receiving an indication that a first end user of the plurality of end users is logging in. In other embodiments, the CUI server 210 may transmit the first user interface 105 to a user computer device 205 associated with the first end user to display the first user interface 105 to the first end user.

In some embodiments, the user profiles are stored on the user computer devices 205 and the database 220 and/or CUI server 210 is accessed to generate the user interface for that profile. In other embodiments, the user computer device 205 retrieves the profile from the CUI server 210 and then uses the CUI server 210 and/or the database 220 to generate, populate, and display the user interface to the user.

In some embodiments, the plurality of locations may be x,y coordinates for the locations of the data elements 110. In other embodiment, the plurality of locations may be relative positioning and/or any other positioning and location method that allows the system to work as described herein.

In some further embodiments, the CUI server 210 determines which data elements 110 that the end user interacts with and/or calls up the most. In these embodiments, the CUI server 210 may sort the data elements 110 in the container 115 based on the amount that similar elements are used. In some additional embodiments, the CUI server 210 may suggest data elements 110 based on past end user behavior.

In some additional embodiments, the CUI server 210 stores multiple user profiles for the same end user, where each user profile is for displaying different information. In one example, a first user profile may include data about health insurance, where a second user profile may include information about vehicle insurance. As the data needed for these two categories is different, the CUI server 210 may use the first user profile when health insurance information is called up and the second user profile when vehicle insurance information is called up. In some of these embodiments, the data may be different based on the state in which the individual associated with the data resides in. In these embodiments, there may be different user profiles based on the state of the individual being view.

In still further embodiments, when the end user requests data from the database 220, the CUI server 210 determines which fields are to be shown based on the user profile and only requests data for those fields. In other embodiments, the CUI server 210 may request an entire record and sort out which fields are needed to fill the data elements.

In some of these embodiments, the CUI server 210 may generate the user interface 105 to be displayed on the user computer device 205. In other embodiments, the user computer device 205 generates the user interface 105.

### Exemplary Client Device

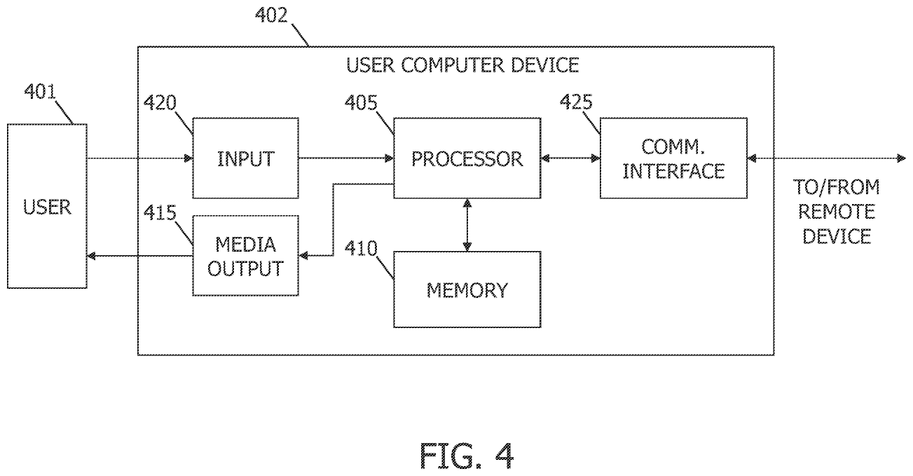

FIG. 4 depicts an exemplary configuration of a client computer device 205 shown in FIG. 2, in accordance with one embodiment of the present disclosure. User computer device 402 may be operated by a user 401. User computer device 402 may include, but is not limited to, user computer devices 205 (shown in FIG. 2). User computer device 402 may include a processor 405 for executing instructions. In some embodiments, executable instructions are stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets).

In some embodiments, media output component 415 may be configured to present a graphical user interface (e.g., a web browser and/or a client application) to user 401. A graphical user interface may include, for example, an online store interface for viewing and/or purchasing items, and/or a wallet application for managing payment information. In some embodiments, user computer device 402 may include an input device 420 for receiving input from user 401. User 401 may use input device 420 to, without limitation, select and/or enter one or more items to purchase and/or a purchase request, or to access credential information, and/or payment information.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as the CUI server 210 (shown in FIG. 2). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from the CUI server 210. A client application allows user 401 to interact with, for example, the CUI server 210. For example, instructions may be stored by a cloud service, and the output of the execution of the instructions sent to the media output component 415.

Processor 405 executes computer-executable instructions for implementing aspects of the disclosure. In some embodiments, the processor 405 is transformed into a special purpose microprocessor by executing computer-executable instructions or by otherwise being programmed.

### Exemplary Server Device

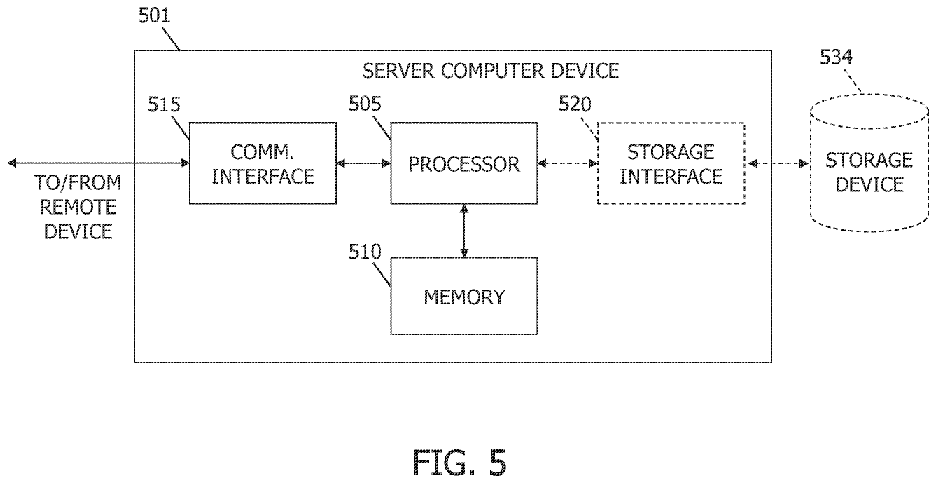

FIG. 5 depicts an exemplary configuration of a server 210 shown in FIG. 2, in accordance with one embodiment of the present disclosure. Server computer device 501 may include, but is not limited to, database server 215 and/or CUI server 210 (both shown in FIG. 2). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, or user computer devices 205 (shown in FIG. 2). For example, communication interface 515 may receive requests from user computer devices 205 via the Internet, as illustrated in FIG. 2.

Processor 505 may also be operatively coupled to a storage device 534. Storage device 534 may be any computer-operated hardware suitable for storing and/or retrieving data, such as, but not limited to, data associated with database 220 (shown in FIG. 2). In some embodiments, storage device 534 may be integrated in server computer device 501. For example, server computer device 501 may include one or more hard disk drives as storage device 534.

In other embodiments, storage device 534 may be external to server computer device 501 and may be accessed by a plurality of server computer devices 501. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instructions such as illustrated in FIG. 3.

### Exemplary Embodiments & Functionality

In one embodiment, a computer system for generating a customizable user interface may be provided. The computer system may include one or more local or remote processors, transceivers, servers, sensors, memory units, wearables, mobile devices, smart glasses, smart watches, augmented reality glasses, virtual reality headsets, and/or other electronic or electrical components. For example, in one instance, the system may include at least one processor (and/or associated transceiver) in communication with at least one memory device. The at least one processor may be configured or programmed to: (1) receive an indication to activate a customization mode for a user interface from an end user; (2) determine a role and one or more permissions for the end user; (3) retrieve one or more containers of data elements based on the role for the end user; (4) populate each of the one or more containers with a plurality of data elements based on the one or more permissions for the end user; (5) display the customization mode for the user interface including the one or more containers to the end user; (6) receive one or more changes to the user interface from the end user; and/or (7) update a profile for the end user based on the one or more changes. The computer system may have additional, less, or alternate functionality, including that discussed elsewhere herein.

For instance, in some further enhancements, the computer system may retrieve the profile for the end user from a database. The computer system may retrieve the role and the one or more permissions from the profile. Further, the computer system may receive the indication to activate the customization mode is based on an input from the end user.

In additional enhancements, the computer system may store the profile for the user interface as a first profile. The computer system may configure the profile for the role and the one or more permissions as a second profile. The first profile and the second profile may be different.

In at least one enhancement, the computer system may store a plurality of profiles for a plurality of end users. The computer system may also retrieve a first profile for a first end user. The computer system may further generate a first user interface for the first end user based on the first profile. In addition, the computer system may retrieve the first profile for the first end user in response to receiving an indication that a first end user of the plurality of end users is logging in. Moreover, the computer system may transmit the first user interface to a user computer device associated with the first end user to display the first user interface to the first end user.

In some enhancements, the profile includes a plurality of data elements to display and a plurality of locations on the user interface to display the plurality of data elements. The profile may include at least one of a size of one or more of the plurality of data elements, a color of one or more of the plurality of data elements, a font of one or more of the plurality of data elements, or a color of a font of one or more of the plurality of data elements.

In another aspect, a computer-based method for generating a customizable user interface may be provided. The computer-based method may be implemented via one or more local or remote processors, transceivers, sensors, servers, memory units, mobile devices, wearables, smart glasses, smart watches, augmented reality glasses, virtual reality headsets, and/or other electronic or electrical components. For example, in one instance, the method may be implemented on a customizable user interface (“CUI”) server that includes at least one processor (and/or associated transceiver) in communication with at least one memory device. The method may include, via the at least one processor: (1) receiving an indication to activate a customization mode for a user interface from an end user; (2) determining a role and one or more permissions for the end user; (3) retrieving one or more containers of data elements based on the role for the end user; (4) populating each of the one or more containers with a plurality of data elements based on the one or more permissions for the end user; (5) displaying the customization mode for the user interface including the one or more containers to the end user; (6) receiving one or more changes to the user interface from the end user; and/or (7) updating a profile for the end user based on the one or more changes. The method may include additional, less, or alternate actions, including those discussed elsewhere herein.

In yet another aspect, at least one non-transitory computer-readable storage media having computer-executable instructions embodied thereon may be provided. When executed by at least one processor, the computer-executable instructions cause the processor to: (1) receive an indication to activate a customization mode for a user interface from an end user; (2) determine a role and one or more permissions for the end user; (3) retrieve one or more containers of data elements based on the role for the end user; (4) populate each of the one or more containers with a plurality of data elements based on the one or more permissions for the end user; (5) display the customization mode for the user interface including the one or more containers to the end user; (6) receive one or more changes to the user interface from the end user; and/or (7) update a profile for the end user based on the one or more changes. The computer-executable instructions may direct additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system for generating a customizable user interface, the computer system including at least one processor in communication with at least one memory device, the at least one processor programmed to:
receive an indication to activate a customization mode for a user interface from an end user;
determine a role and one or more permissions for the end user;
retrieve one or more containers of data elements based on the role for the end user;
populate each of the one or more containers with a plurality of data elements based on the one or more permissions for the end user;
display the customization mode for the user interface including the one or more containers to the end user;
receive one or more changes to the user interface from the end user; and
update a profile for the end user based on the one or more changes.

2. The computer system of claim 1, wherein the indication to activate the customization mode is based on an input from the end user.

3. The computer system of claim 1, wherein to determine a role and one or more permissions for the end user, the at least one processor is further programmed to:
retrieve the profile for the end user from a database; and
retrieve the role and the one or more permissions from the profile.

4. The computer system of claim 3, wherein the profile for the user interface is a first profile, wherein the profile for the role and the one or more permissions is a second profile, and wherein the first profile and the second profile are different.

5. The computer system of claim 1, wherein the at least one processor is further programmed to:
store a plurality of profiles for a plurality of end users;
retrieve a first profile for a first end user; and
generate a first user interface for the first end user based on the first profile.

6. The computer system of claim 5, wherein the at least one processor is further programmed to retrieve the first profile for the first end user in response to receiving an indication that a first end user of the plurality of end users is logging in.

7. The computer system of claim 5, wherein the at least one processor is further programmed to transmit the first user interface to a user computer device associated with the first end user to display the first user interface to the first end user.

8. The computer system of claim 1, wherein the profile includes a plurality of data elements to display and a plurality of locations on the user interface to display the plurality of data elements.

9. The computer system of claim 8, wherein the profile includes at least one of a size of one or more of the plurality of data elements, a color of one or more of the plurality of data elements, a font of one or more of the plurality of data elements, or a color of a font of one or more of the plurality of data elements.

10. A computer-based method for generating a customizable user interface implemented on a customizable user interface (“CUI”) server that includes at least one processor and/or associated transceiver in communication with at least one memory device, wherein the method comprises:
receiving an indication to activate a customization mode for a user interface from an end user;
determining a role and one or more permissions for the end user;
retrieving one or more containers of data elements based on the role for the end user;
populating each of the one or more containers with a plurality of data elements based on the one or more permissions for the end user;
displaying the customization mode for the user interface including the one or more containers to the end user; and
receiving one or more changes to the user interface from the end user;
updating a profile for the end user based on the one or more changes.

11. The computer-based method of claim 10, wherein the indication to activate the customization mode is based on an input from the end user.

12. The computer-based method of claim 10, wherein to determine a role and one or more permissions for the end user, the method further comprises:
retrieving the profile for the end user from a database; and
retrieving the role and the one or more permissions from the profile.

13. The computer-based method of claim 10, wherein the profile for the user interface is a first profile, wherein the profile for the role and the one or more permissions is a second profile, and wherein the first profile and the second profile are different.

14. The computer-based method of claim 10 further comprising:
storing a plurality of profiles for a plurality of end users;
retrieving a first profile for a first end user; and
generating a first user interface for the first end user based on the first profile.

15. The computer-based method of claim 14 further comprising retrieving the first profile for the first end user in response to receiving an indication that a first end user of the plurality of end users is logging in.

16. The computer-based method of claim 14 further comprising transmitting the first user interface to a user computer device associated with the first end user to display the first user interface to the first end user.

17. The computer-based method of claim 10, wherein the profile includes a plurality of data elements to display and a plurality of locations on the user interface to display the plurality of data elements.

18. The computer-based method of claim 17, wherein the profile includes at least one of a size of one or more of the plurality of data elements, a color of one or more of the plurality of data elements, a font of one or more of the plurality of data elements, or a color of a font of one or more of the plurality of data elements.

19. At least one non-transitory computer-readable storage media having computer-executable instructions embodied thereon, when executed by at least one processor, the computer-executable instructions cause the processor to:
receive an indication to activate a customization mode for a user interface from an end user;
determine a role and one or more permissions for the end user;
retrieve one or more containers of data elements based on the role for the end user;
populate each of the one or more containers with a plurality of data elements based on the one or more permissions for the end user;
display the customization mode for the user interface including the one or more containers to the end user;
receive one or more changes to the user interface from the end user; and
update a profile for the end user based on the one or more changes.

20. The at least one non-transitory computer-readable storage media of claim 19, wherein the instructions further cause the processor to:
store a plurality of profiles for a plurality of end users;
retrieve a first profile for a first end user in response to receiving an indication that a first end user of the plurality of end users is logging in;
generate a first user interface for the first end user based on the first profile; and
transmit the first user interface to a user computer device associated with the first end user to display the first user interface to the first end user.
